(19) United States
(12) Patent Application Publication
(10) Pub. No.: US 2014/0143650 A1
(43) Pub. Date: May 22, 2014

(54) Coordinated Dual Display Screens

(71) Applicants: Eitan Lev, Even Yehuda (IL); Mordechai Teicher, Hod Hasharon (IL)

(72) Inventors: Eitan Lev, Even Yehuda (IL); Mordechai Teicher, Hod Hasharon (IL)

(21) Appl. No.: 13/679,871

(22) Filed: Nov. 16, 2012

(51) Int. Cl. G06F 17/20

(52) U.S. Cl. CPC G06F 17/20
USPC 715/234

(57) ABSTRACT

A method, system, and apparatus for coordinated presentation of web content on a handheld device having a portable display screen paired with a stationary device having a stationary display screen. If a pairing is detected, a visual channel component of web content video is automatically presented on the stationary device, while a text component is automatically presented on the handheld device. In addition, the visual channel is also blocked from presentation on the handheld device and/or the text component is also blocked from presentation on the stationary device.

### FIELD

The present invention relates to presentation of web content and, more particularly, to a method, apparatus, and system for coordinated dual-screen presentation of web content.

### BACKGROUND

The widespread availability of versatile handheld devices such as smart phones and tablets has encouraged their use for presentation of web content, including text content and streaming video content. A user of a handheld device, however, may prefer to view video content on a larger screen, such as a television screen or similar stationary device, while continuing to view the text content on the handheld device, especially in the case of text related to interactive user input. It would therefore be desirable to have methods, apparatus, and systems for automatically coordinating the presentation of the web content on the stationary display screen and the handheld display screen. This goal is met by the present invention.

### SUMMARY

Embodiments of the present invention provide for automatically-coordinated presentation of web content on a handheld portable device that is paired with a stationary device. According to various embodiments, if a pairing is detected, a visual channel component of web content video is automatically presented on the stationary device, while a text component is automatically presented on the handheld device. According to certain embodiments, the visual channel is also blocked from presentation on the handheld device and/or the text component is also blocked from presentation on the stationary device.

In further embodiments, for presentation of an aural channel component of the web content video, the user may select no device (muting of the aural channel), one device only (either the handheld device or the stationary device), or both devices (both the handheld device and the stationary device).

Therefore, according to an embodiment of the present invention there is provided a method for presenting web content to a user, the web content including at least a text content element and a streaming video content element, wherein the streaming video content element includes a visual channel and an aural channel, the method including: (a) receiving, in a handheld device of the user, a first user input identifying a web page containing the web content; (b) retrieving the web content by the handheld device; (c) detecting whether the handheld device is paired with a stationary device; and (d) if the handheld device is paired with a stationary device, then automatically: (e) presenting the text content element on the handheld device; (f) presenting the visual channel on the stationary device, and, at least one of: (g) excluding the text content element from being presented on the stationary device, or (h) excluding the visual channel from being presented on the handheld device; and (i) if the handheld device is not paired with any stationary device, then presenting both the text content element and the visual channel on the handheld device.

In addition, according to another embodiment of the present invention there is provided a system for presenting web content to a user, the web content including at least a text content element and a streaming video content element, wherein the streaming video content element includes a visual channel and an aural channel, the system including: (a) a stationary device that includes a stationary device screen; (b) a handheld device that includes a portable device screen; (c) an input device operative to receive a first user input identifying a web page containing the web content; and (d) a processor configured: (e) to retrieve the web content; (f) to detect or whether the handheld device is paired with the stationary device, and (g) responsively to the handheld device being paired with the stationary device: (h) to automatically present the text content element on the portable device screen; (i) to automatically send the visual channel to the stationary device for presentation on the stationary device screen; and (j) at least one of: (k) to automatically exclude the visual channel from being presented on the portable device screen; or (l) to automatically exclude the text content element from being sent to the stationary device; and (m) responsively to the handheld device not being paired with the stationary device, to automatically present both the text content element and the visual channel on the portable device screen.

Moreover, according to still another embodiment of the present invention there is provided a handheld device including: (a) a portable device screen; (b) an input device operative to receive a first user input identifying a web page that includes web content having at least a text content element and a streaming video content element, the streaming video content element including a visual channel and an aural channel; and (c) a processor configured: (d) to retrieve the web content; (e) to detect whether the handheld device is paired with a stationary device that includes a stationary device screen; and (f) responsively to the handheld device being paired with the stationary device: (g) to automatically present the text content element on the portable device screen; (h) to exchange data with the stationary device to automatically present the visual channel on the stationary device screen; and (i) to perform at least one of: (j) automatically excluding the visual channel from being presented on the portable device screen; or (k) exchanging data with the stationary device to exclude the text content element from being presented on the stationary device screen; and (l) responsively to the handheld device not being paired with the stationary device, to automatically present both the text content element and the visual channel on the portable device screen.

### BRIEF DESCRIPTION OF THE DRAWINGS

The present invention will be more fully understood from the following detailed description of the embodiments thereof, taken together with the drawings in which:

FIG. 1 conceptually illustrates background-art components of web content that are relevant to embodiments of the present invention.

FIG. 2A conceptually illustrates a pairing of a handheld device and a stationary device according to an embodiment of the present invention.

FIG. 2B conceptually illustrates a pairing of a handheld device and a stationary device according to another embodiment of the present invention.

FIG. 2C conceptually illustrates a pairing of a handheld device and a stationary device according to a further embodiment of the present invention.

FIG. 3 conceptually illustrates a system for coordinated dual display according to an embodiment of the present invention.

FIG. 4 conceptually illustrates functionality of a handheld device according to an embodiment of the present invention.

FIG. 5 is a flowchart illustrating coordinated display methods according to certain embodiments of the present invention.

### DEFINITIONS

### Web Content

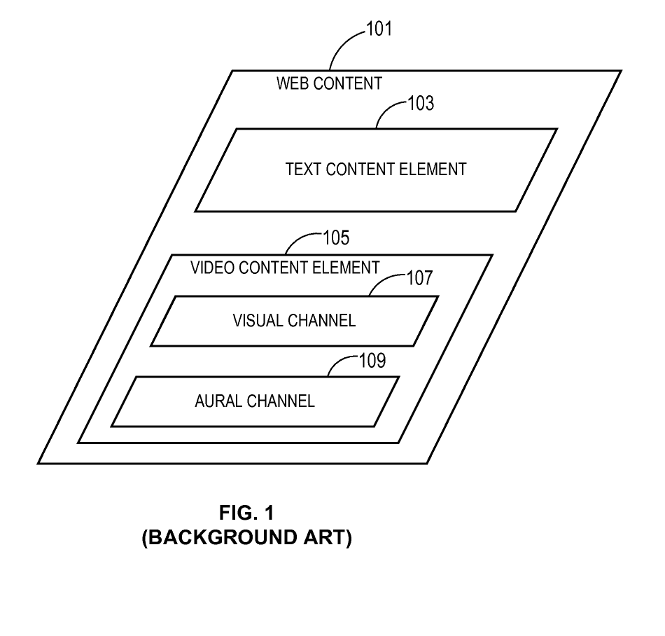

The term “web content” herein denotes Internet-available content data for presentation to a human user, which specifically includes both text and streaming video, where the video has both a visual component and an aural component. As conceptually illustrated in FIG. 1, web content 101 includes a text content element 103 and a video content element 105 containing a visual channel 107 and an aural channel 109.

### Display/Presentation

The terms “display” and “presentation” herein denote the setting forth of web content to a user, and both terms herein encompass aural channel web content as well as text and visual channel content. Text presentation and visual channel presentation are via a display screen, and aural channel presentation is via a user-selectable audio transducer that creates audible sounds corresponding to electrical signals representing aural channel content; non-limiting examples of such transducers include speakers, earphones, and headphones. The term “user-selectable” herein denotes that the user may select zero or more specific transducers on specific devices for the presentation of aural channel content. The selection of zero transducers is equivalent to the concept of “muting”, in which sound output is disabled or suppressed. The terms “play”, “playing”, etc., are herein equivalent to the terms “presentation” regarding video content for both visual channel and aural channel content. The terms “show”, “showing”, etc., and “display”, “displaying”, etc., are herein equivalent to the terms “presentation” regarding video content, especially for visual channel content.

### Handheld Device

The term “handheld device” herein denotes any device capable of presenting web content that is designed and configured for personal portable use, and includes an internal self-contained battery-source power supply. A handheld device according to embodiments of the present invention also includes a capability to receive and process user input. User input is via a designated input component, non-limiting examples of which include: buttons, switches, keys/keypads/keyboards, touch-sensitive screens or touch-sensitive pad devices, accelerometers, microphones for receiving voice commands, and image-forming components such as cameras for capturing visible gestures. Non-limiting examples of handheld devices include: cellular telephones, tablet computers, and similar portable devices having wireless network connectivity.

A handheld device according to embodiments of the present invention may optionally include a stand or holder for hands-free operation and use, or may be configured with a separate or detachable stand or holder. In addition, a handheld device according to embodiments of the present invention typically includes an external power input for battery recharging and/or extended time use, which may be optionally configured together with a stand or holder. It is understood, however, that the presence or use of a stand or holder, and/or the use of an external power input does not disqualify the device from being a personally portable “handheld device” according to embodiments of the present invention.

According to various embodiments of the invention, a handheld device has a portable display screen. When text content and visual channel content is said to be “displayed” on the handheld device, it is understood that the content is presented on the portable display screen of the handheld device.

According to an embodiment of the invention, a handheld device also includes one or more speakers for presentation of aural channel content. In alternative embodiments, a handheld device includes one or more jacks for connecting earphones and/or headphones to the handheld device for presentation of aural channel content.

### Stationary Device

The term “stationary device” herein denotes any device capable of presenting web content that is designed and configured substantially as a non-portable device for use in a particular location. A stationary device according to embodiments of the present invention typically receives operating power from electrical mains and may optionally include a remote control device, such as a wireless remote control device, for operating the stationary device. Non-limiting examples of stationary devices include television sets, home entertainment centers, wall- and stand-mounted flat-screen displays, projection systems, and desktop computer displays.

According to various embodiments of the invention, a stationary device has a stationary display screen. When text content and visual channel content is said to be “displayed” on the stationary device, it is understood that the content is presented on the stationary display screen of the stationary device.

According to an embodiment of the invention, a stationary device also includes one or more speakers for presentation of aural channel content.

### Pairing of Devices

The terms “pairing”, “paired”, and the like with respect to devices herein denote that a content-associated relationship exists between a specific handheld device and a specific stationary device.

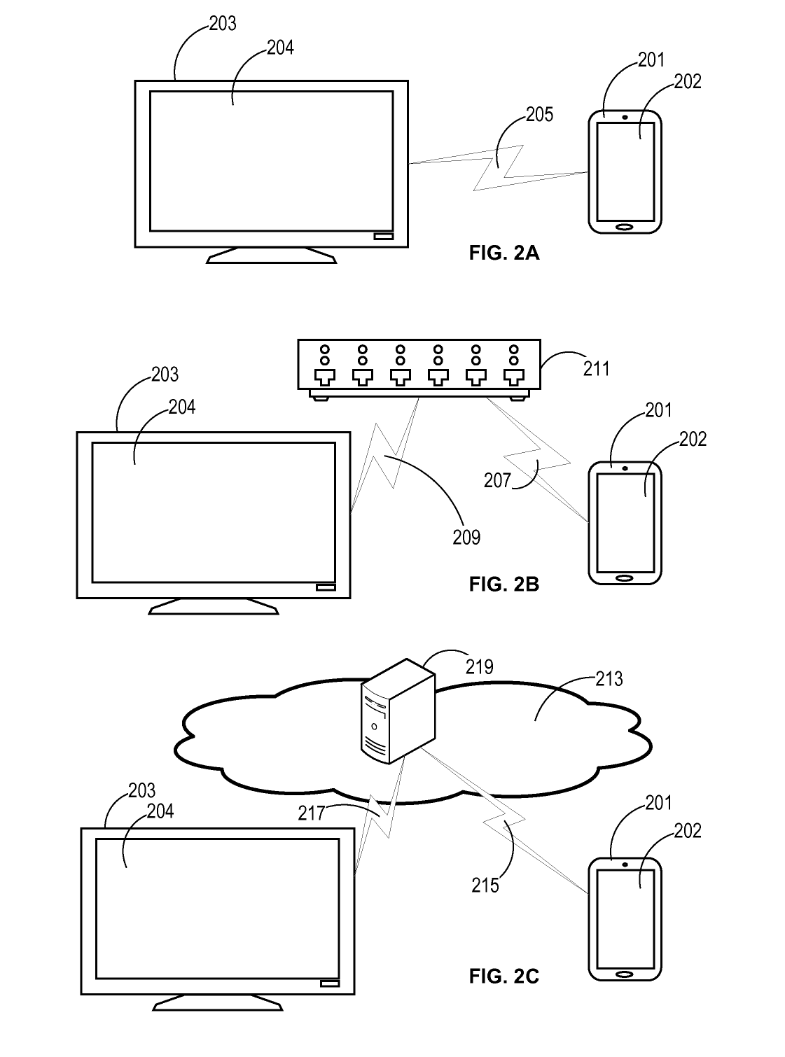

In an embodiment of the invention illustrated in FIG. 2A, a handheld device 201 having a portable device screen 202 is paired with a stationary device 203 having a stationary screen 204 via a direct data link 205 between the paired devices. In another embodiment of the invention illustrated in FIG. 2B, handheld device 201 is paired with stationary device 203 via mutual data connections 207 and 209, respectively, through a local device 211. A non-limiting example of local device 211 is a home entertainment router. In a further embodiment of the invention illustrated in FIG. 2C, handheld device 201 is paired with stationary device 203 via mutual data links 215 and 217, respectively, over a network 213 to a server 219. In a non-limiting example, network 213 is the Internet, and server 219 is a dedicated server for pairing handheld and stationary devices.

According to various embodiments of the invention, paired devices are operative to coordinate the presentation of web content as described herein.

According to certain embodiments of the present invention, it is possible to determine if a specific handheld device is paired with a stationary device. According to related embodiments of the present invention, a handheld device is able to determine if it is paired with a stationary device.

### Blocking/Excluding Content

The terms “block”, “blocking”, etc., and “exclude”, “excluding”, etc. herein are used equivalently to denote that specified content is actively not presented on specified devices of paired devices. As a non-limiting example, in various embodiments of the invention, when a handheld device is paired with a stationary device, text content is presented on the handheld device and is not presented on the stationary device. In particular embodiments, text content is blocked, or actively excluded from being presented on the stationary device.

In a non-limiting embodiment, blocking/excluding is effected by preventing content from being presented on a specified device, such as by disabling the transfer of the content to the device or by disabling the presentation of the content at the device itself. In another non-limiting embodiment, blocking/excluding is effected by not enabling the transfer of the content to the device, or by not enabling the presentation of the content at the device. In still another non-limiting embodiment, blocking/excluding is effected by omitting the transfer of the content to the device, or by omitting the performing of the presentation of the content at the device. In a further non-limiting embodiment, blocking/excluding is effected by the use of a blocking filter that prevents the transfer of the content to the device. In a related embodiment, a pass filter enables transfer of content where blocking/excluding is not applicable.

### DETAILED DESCRIPTION

The principles and operation of a dual screen system and method according to embodiments of the present invention may be understood with reference to the drawings and the accompanying description.

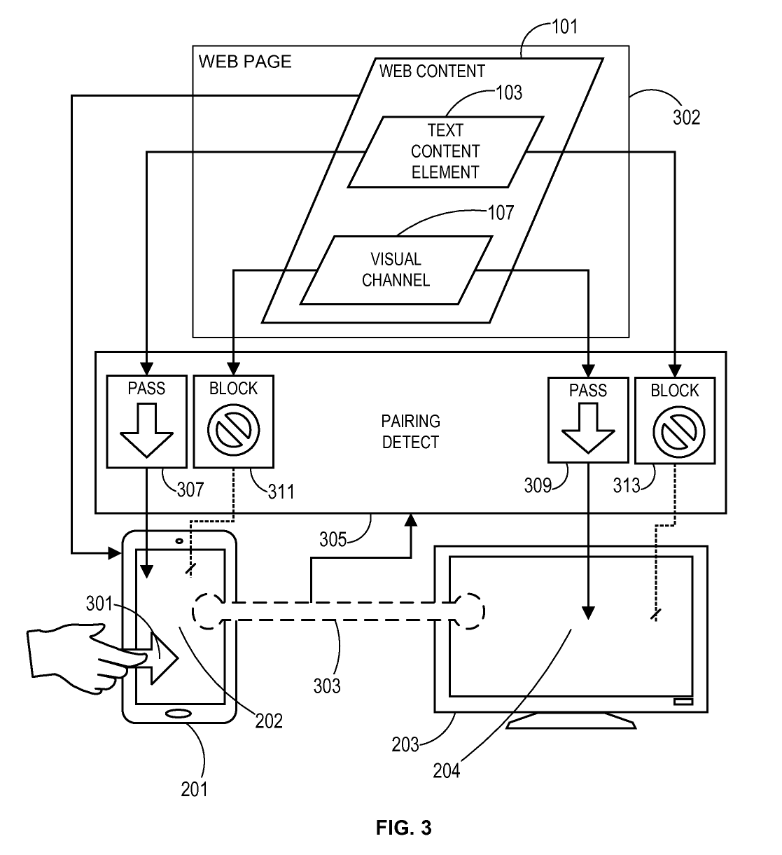

FIG. 3 conceptually illustrates a system for coordinated dual display on handheld device 201 having portable device screen 202 and stationary device 203 having a stationary device screen 204 according to an embodiment of the present invention. Handheld device 201 receives a user input 301 (such as via touch-screen entry, push-button entry, or key/keypad/keyboard entry) identifying a web-page 302 containing web content 101, which is then retrieved by handheld device 201.

A pairing detect functionality 305 detects whether handheld device 201 is paired with stationary device 203 (i.e., if there exists a pairing 303). If handheld device 201 is paired with stationary device 203, text content element 103 is automatically passed via a pass filter 307 for presentation on portable device screen 202. Simultaneously, visual channel 107 is blocked from presentation on portable device screen 202 by a blocking filter 311. Visual channel 107, however, is presented on stationary device screen 204 via a pass filter 309, while text content element 103 is blocked via a blocking filter 313 to exclude text content element 103 from being presented via stationary device 203 on stationary device screen 204.

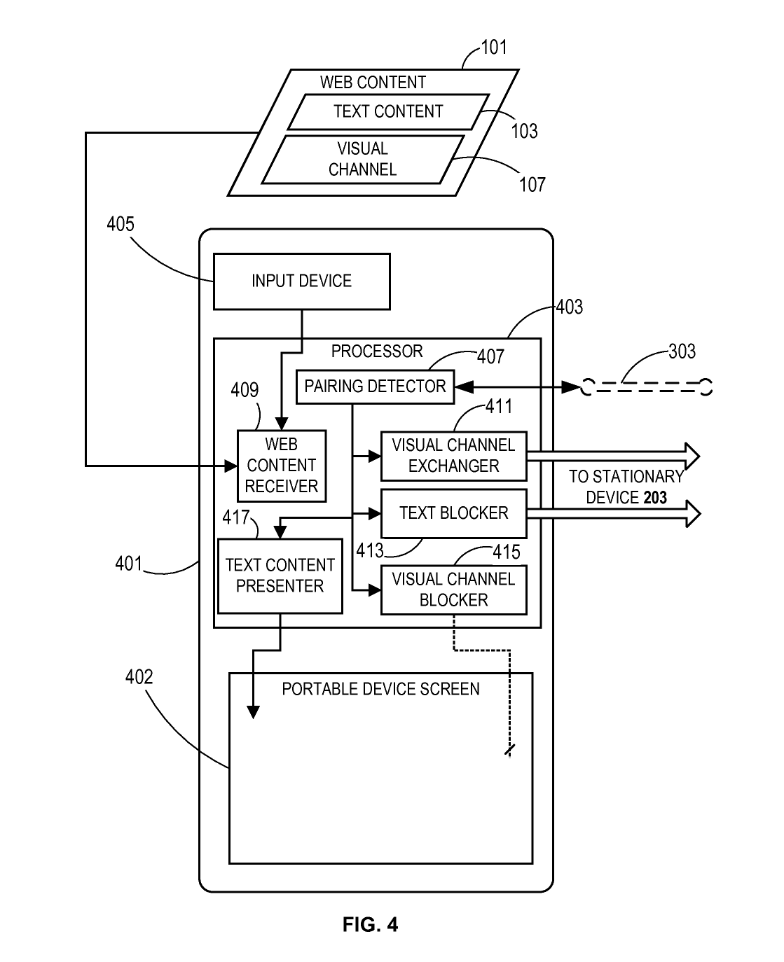

FIG. 4 conceptually illustrates functionality of a handheld device 401 having a portable device screen 402 according to an embodiment of the present invention. A processor 403 implements the various functionalities of the embodiment as described herein. Implementation can be effected via software and/or firmware and/or hardware components and/or combinations thereof for processor 403. Functionalities are illustrated in FIG. 4 as being those of processor 403, although in other embodiments of the present invention, the functionalities are implemented in other configurations featuring software/firmware/hardware elements distinct from processor 403.

A user input device 405 provides user input to processor 403, particularly in the case of identifying the location of web content to be retrieved via a web content receiver 409. A pairing detector 407 detects pairing 303 (FIG. 3) and triggers: a text content presenter 417 to display text content 103 on portable device screen 402; a visual channel exchanger 411 to send visual channel 107 to paired stationary device 203 (as shown in FIG. 3); a text blocker 413 to exclude text content 103 from presentation on paired stationary device 203; and a visual channel blocker 415 to exclude visual channel presentation on portable device screen 402.

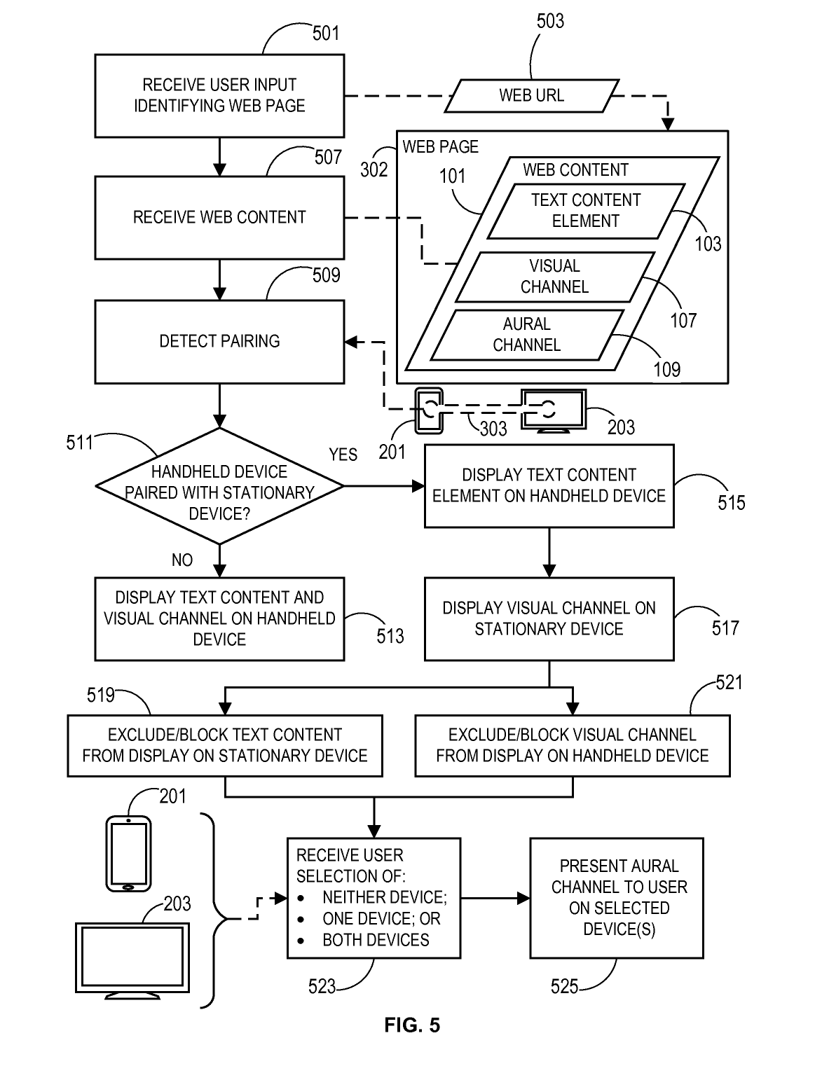

FIG. 5 is a flowchart illustrating coordinated display methods according to certain embodiments of the present invention. In a step 501, user input is received identifying web page 302 containing web content 101. In a related embodiment, the user specifies a Web URL 503 to identify web page 302. In a step 507 web content 101 is received.

In a step 509, pairing 303 is detected. At a decision point 511 if handheld device 201 is paired with stationary device 203, then in a step 515 text content element 103 is displayed on handheld device 201 and in a step 517 visual channel 107 is displayed on stationary device 203.

In an embodiment of the invention, in a step 519 text element content 103 is blocked or excluded from presentation on stationary device 203. In an alternative embodiment, in a step 521 visual channel content 107 is blocked or excluded from presentation on handheld device 201. In still another embodiment, both step 519 and step 521 are performed.

At decision point 511 if handheld device 201 is not paired with a stationary device (such as stationary device 203) then in a step 513, both text element content 103 and visual channel content 107 are displayed on handheld device 201.

In additional embodiments of the invention, in a step 523 a user selection is received, wherein the user selects zero or more devices for presentation of aural channel content 109. In these embodiments, the user chooses: neither handheld device 201 nor stationary device 203; handheld device 201 only; stationary device 203 only; or both handheld device 201 and stationary device 203. Then, in a step 525, aural channel content 109 is presented to the user via the selected device(s). The case where the user chooses neither handheld device 201 nor stationary device 203 is equivalent to the muting of aural channel content 109.

While the invention has been described with respect to a limited number of embodiments, it will be appreciated that many variations, modifications and other applications of the invention may be made.

1. A method for presenting web content to a user, the web content including at least a text content element and a streaming video content element, wherein the streaming video content element includes a visual channel and an aural channel, the method comprising:
receiving, in a handheld device of the user, a first user input identifying a web page containing the web content;
retrieving the web content by the handheld device;
detecting whether the handheld device is paired with a stationary device; and
if the handheld device is paired with a stationary device, then automatically:
presenting the text content element on the handheld device;
presenting the visual channel on the stationary device, and, at least one of:
excluding the text content element from being presented on the stationary device, or
excluding the visual channel from being presented on the handheld device; and
if the handheld device is not paired with any stationary device, then presenting both the text content element and the visual channel on the handheld device.

2. The method of claim 1, further comprising:
if the handheld device is paired with a stationary device, receiving a second user input indicating at least one device selected from a group consisting of:
the handheld device; and
the stationary device; and
according to the second user input: playing the aural channel on the at least one device.

3. A system for presenting web content to a user, the web content including at least a text content element and a streaming video content element, wherein the streaming video content element includes a visual channel and an aural channel, the system comprising:
a stationary device that includes a stationary device screen;
a handheld device that includes a portable device screen;
an input device operative to receive a first user input identifying a web page containing the web content; and
a processor configured:
to retrieve the web content;
to detect or whether the handheld device is paired with the stationary device, and
responsively to the handheld device being paired with the stationary device:
to automatically present the text content element on the portable device screen;
to automatically send the visual channel to the stationary device for presentation on the stationary device screen; and
at least one of:
to automatically exclude the visual channel from being presented on the portable device screen; or
to automatically exclude the text content element from being sent to the stationary device; and
responsively to the handheld device not being paired with the stationary device, to automatically present both the text content element and the visual channel on the portable device screen.

4. The system of claim 3, wherein the input device is further operative to receive a second user input indicating that the aural channel is to be played on at least one device selected from a group consisting of:
the handheld device; and
the stationary device;
wherein the system is further operative to play the aural channel on the at least one device.

5. A handheld device comprising:
a portable device screen;
an input device operative to receive a first user input identifying a web page that includes web content having at least a text content element and a streaming video content element, the streaming video content element including a visual channel and an aural channel; and
a processor configured:
to retrieve the web content;
to detect whether the handheld device is paired with a stationary device that includes a stationary device screen; and
responsively to the handheld device being paired with the stationary device:
to automatically present the text content element on the portable device screen;
to exchange data with the stationary device to automatically present the visual channel on the stationary device screen; and
to perform at least one of: automatically excluding the visual channel from being presented on the portable device screen; or exchanging data with the stationary device to exclude the text content element from being presented on the stationary device screen; and
responsively to the handheld device not being paired with the stationary device, to automatically present both the text content element and the visual channel on the portable device screen.

6. The handheld device of claim 5, wherein the input device is further operative to receive a second user input indicating that the aural channel is to be played on at least one device selected from a group consisting of:
the handheld device; and
the stationary device;
wherein the handheld device is further operative to play the aural channel on the at least one device.
